(19) United States
(12) Patent Application Publication
(10) Pub. No.: US 2012/0280571 A1
(43) Pub. Date: Nov. 8, 2012

(54) VOLTAGE COMPENSATION

(75) Inventor: Colin Hargis, Oswestry (GB)

(73) Assignee: CONTROL TECHNIQUES LTD, Newtown, Powys (GB)

(21) Appl. No.: 13/384,697

(22) PCT Filed: Dec. 20, 2010
(86) PCT No.: PCT/EP2010/070192

§ 371 Date: Mar. 30, 2012

(30) Foreign Application Priority Data
Dec. 23, 2009 (GB) 0922609.3

(51) Int. Cl. G05F 1/67; H02J 1/00

(52) U.S. Cl. 307/77

(57) ABSTRACT

An apparatus is provided for producing a compensated voltage output comprising at least one photovoltaic module biasing means connected in series with the at least one photovoltaic module. The biasing means is operable to generate a controllable bias voltage for modulating an output voltage of the at least one photovoltaic module to produce the compensated voltage output.

### CROSS-REFERENCE TO RELATED APPLICATIONS

This application is a 371 U.S. National Stage of International Application No. PCT/EP2010/070192, filed Dec. 20, 2010, and claims priority to British patent application No. 0922609.3, filed Dec. 23, 2009, the disclosures of which are herein incorporated by reference in their entirety.

### FIELD

This disclosure relates to voltage compensation and to providing voltage compensation within arrays of elements supplying a common direct current inverter.

### BACKGROUND

This section provides background information related to the present disclosure which is not necessarily prior art.

With the present drive to provide ‘green’ energy, the use of photovoltaic (PV) panels is becoming more common. Because the use of these panels is still developing and production volumes are relatively low. The unit cost per panel is relatively high. When coupled with the drive to provide energy efficiently, it is clearly desirable to arrange the PV panels to be operated as efficiently as possible.

PV panels are typically connected in series strings and produce a suitable direct current (DC) voltage typically for conversion to alternating current (AC) by an accompanying inverter or other electrical converter in an associated power processing system.

For a given level of insolation (exposure to the sun) and temperature, each PV panel has an optimal DC operating voltage which is typically determined and followed using an automatic Maximum Power Point (MPP) tracking algorithm running in the associated power processing system. The MPP algorithm searches for the point in the I-V output curve of a PV panel where the output power begins to drop as increased current is drawn.

The power lost in the control equipment of the associated power processing system is a large factor in the cost effective operation of PV panels. A specific difficulty with such systems is that because of the natural variation of insolation, the average power produced by the array is much less than the maximum rating of the array. The fixed power losses in the associated power processing system, being a function of the maximum rating, are therefore relatively high and they have a disproportionate effect on the overall efficiency of energy conversion.

With a large array of PV panels, a number of series strings of panels are often connected in a parallel arrangement. Typically, a large common inverter is connected across the series strings. The large common inverter can be cost-effectively designed with multiple power devices (semiconductors) which can be controlled so that only those required for the prevailing level of power generation are active. The losses, and especially the fixed losses, of the individual devices are therefore adapted to the level of power generation.

The disadvantage of this arrangement is that the MPP tracking algorithm in the inverter can only adjust the voltage across all of the series strings in common. Differences in the voltages produced by each PV string in the array, such as those caused by differing temperature, sun angle, shading, and a non-uniform ageing process in each panel etc., cannot be catered for.

Alternatively, each series string of PV panels may be connected with its own smaller inverter. The advantage of employing an inverter associated with each series string is that each string may be provided with an independent MPP tracking algorithm and control system. The cost of individual inverters is high. This arrangement exhibits reduced efficiency at other than maximum rated power because the inverter cannot be cost-effectively adapted to the power demand. The fixed losses of each inverter consume a higher proportion of power produced by each string.

There is, therefore, a need to improve the adaptability of voltage generating arrays of elements in an efficient and cost-effective way. A conventional approach to this problem would be to use some form of DC/DC converters between the strings and the input of the common inverter. This has the disadvantage that the entire power throughput of the inverter would pass through this additional stage of power conversion, incurring additional losses proportionate to that power throughput.

### SUMMARY

This section provides a general summary of the disclosure, and is not a comprehensive disclosure of its full scope or all of its features.

Thus there is provided an apparatus according to claim 1 for producing a compensated voltage output including at least one photovoltaic module and biasing means connected in series with the at least one photovoltaic module. The biasing means generates a controllable bias voltage for modulating an output voltage of the at least one photovoltaic module to produce the compensated voltage output.

In various embodiments, the output of each string is individually compensated by the application of a bias voltage in series with the output. The output of each string is optimized according to the overall output of the array by the application of the bias voltage.

In various embodiments, the biasing means is arranged such that the power throughput of the biasing means is proportionate to the bias voltage generated and is less than the total power throughput of the at least one photovoltaic module.

In various embodiments, the apparatus includes a plurality of photovoltaic modules coupled together in series and wherein the biasing means is coupled in series with the photovoltaic modules to form a series string with voltage output terminals.

In various embodiments, the apparatus further comprises a plurality of series strings, at least two series strings being coupled in parallel such that the output terminals of the series strings provide a common photovoltaic module array output.

In various embodiments, the biasing means comprises a DC to DC converter.

In various embodiments, the biasing means further comprises a control device and series string voltage and/or series string current measuring means arranged such that the control device can control the bias voltage imposed on to the voltage output of the series string according to the series string voltage and/or the series string current measurements.

In various embodiments, there is provided a method of compensating a voltage output including exposing at least one photovoltaic module to light such that a DC output voltage is produced by the photovoltaic module and modulating the output voltage with a biasing voltage generated by a biasing means such that the voltage output is compensated.

In various embodiments, the method further comprises measuring the series string voltage and the series string current, inputting the measurements to a maximum power point algorithm of a control device of the biasing means, and providing a control output from the control device to control the biasing voltage imposed by the biasing means such that the output voltage is modulated with a biasing voltage according to the series string voltage and the series string current measurements.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a functional block diagram of a prior art converter arrangement for use with one or more photovoltaic cells;

FIG. 1B illustrates a functional block diagram of a converter arrangement in accordance with various embodiments described herein;

FIG. 1C illustrates a voltage compensation system for photovoltaic panels;

FIG. 2A illustrates an embodiment with a boost mode converter, flyback arrangement;

FIG. 2B illustrates an embodiment with a boost mode converter, forward arrangement;

FIG. 2C illustrates a further embodiment with a boost mode converter, flyback arrangement;

FIG. 2D illustrates a further embodiment with a boost mode converter, forward arrangement;

FIG. 3A illustrates an embodiment with a buck mode converter, flyback arrangement;

FIG. 3B illustrates an embodiment with a buck mode converter, forward arrangement;

FIG. 3C illustrates a further embodiment with a buck mode converter, flyback arrangement;

FIG. 3D illustrates a further embodiment with a buck mode converter, forward arrangement;

FIG. 4A illustrates an embodiment with a bipolar converter with an active rectifier;

FIG. 4B illustrates a further embodiment with a bipolar converter with an active rectifier;

FIG. 5A illustrates an embodiment with a Ćuk converter, boost arrangement;

FIG. 5B illustrates an embodiment with a Ćuk converter, buck arrangement;

FIG. 5C illustrates a further embodiment with a Ćuk converter, boost arrangement;

FIG. 5D illustrates a further embodiment with a Ćuk converter, buck arrangement; and

FIG. 6 illustrates an embodiment as shown in FIG. 2A with a maximum power point tracking controller and associated support components.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

By way of an overview, in a voltage compensation system, series strings of PV modules, or parallel groups of series strings, are each provided with an associated DC to DC converter coupled in series with the string. When the PV modules are exposed to sunlight and hence producing a DC voltage, the converter imposes a bias voltage on the DC voltage of the series string. This results in a string voltage across the string that is not solely dependent on the working voltage of the series string of PV modules for a given level of sunlight.

An MPP tracking algorithm controls the DC to DC converter such that the maximum power output point (or as close to it as is possible) of each string may be maintained. If this is not possible, an average value or other approximation may be used.

When multiple series strings are connected in parallel such that they provide a common array output, a common inverter may be coupled to the array. The inverter is controlled in such a way as to determine the DC voltage, and hence the voltage of the entire PV array. This, in turn, affects the voltage at which the PV series strings operate.

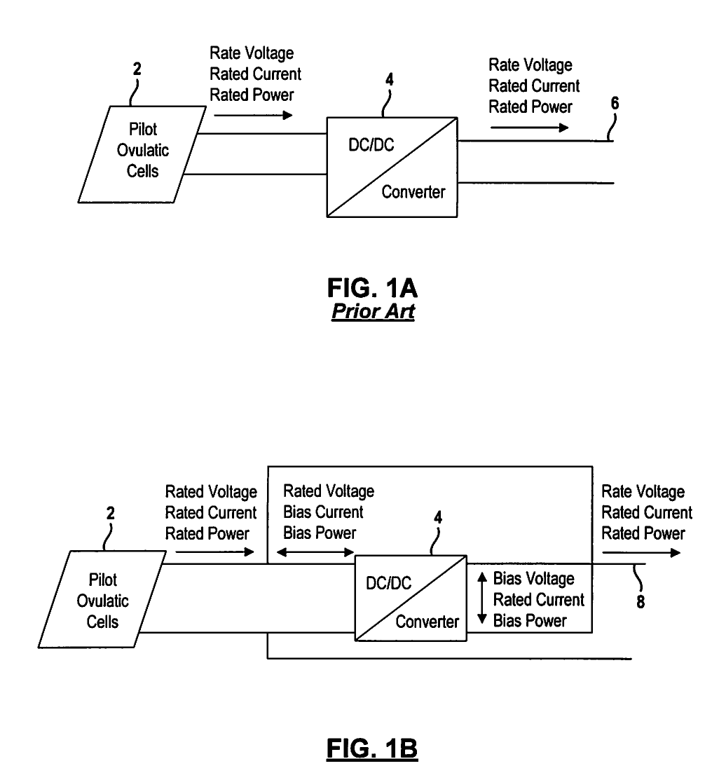

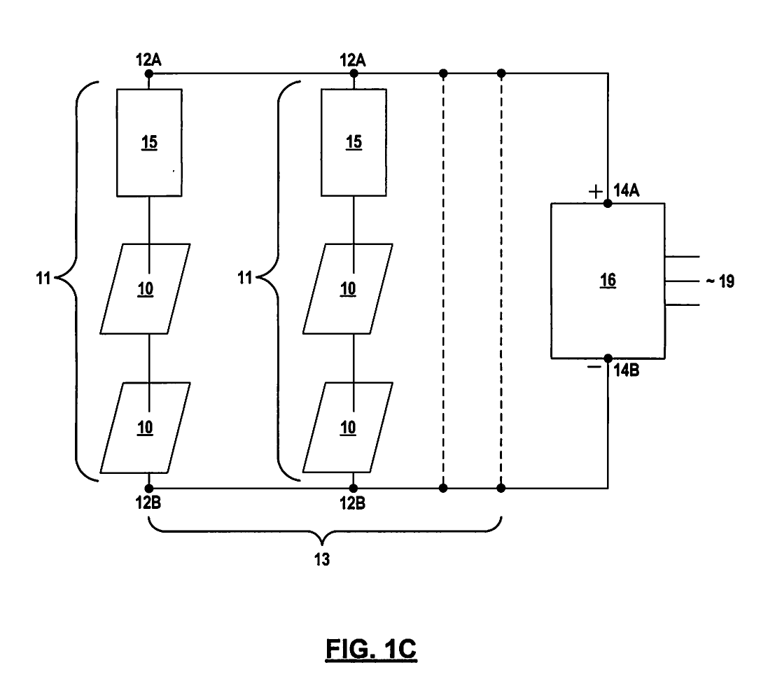

Referring to FIG. 1A, the operation of a conventional DC/DC converter arrangement for use with one or more photovoltaic (PV) cells can be understood. As shown therein, the output from a photovoltaic cell or string of such cells 2 is passed into a DC/DC converter 4 and the output 6 of that converter 4 forms the output of the circuit. As a result, all of the power from the cell or string 2 passes through the converter 4. The purpose of such an arrangement is for the cells or string 2 to be matched in voltage or current with their associated converter or converters 4 so that a plurality of cells or strings 2 may be connected in parallel or series while still operating at their individual optimum power points. While this can be beneficial for the efficiency of the cell or string 2, all of the power flowing through the cell or string 2 also flows through the associated converter 4 and presents a significant drawback since the power rating for the converter 4 must be the same as the power rating for the cell or string 2.

By way of example, the arrangement of in FIG. 1 A may be operated according to a DC/DC converter technique which has a fixed loss of 2% and a variable loss of 4% at full load. If the string 2 was rated as having a 1 kW power peak, the conventionally arranged converter 4 in FIG. 1A must be rated for 1 kW throughput. It would therefore have a fixed loss of 20 W and a variable loss ranging from zero at no load to 40 W at full load. The best possible conversion efficiency would be 94%.

FIG. 1B illustrates a functional block diagram of a converter arrangement in accordance with the embodiments described herein. The PV cells or string 2 are arranged in combination with the DC/DC converter 4 so that the output 8 of the circuit results from a combination of the cells or string 2 and the DC/DC converter 4, rather than being solely from the converter 4. The converter 4 in FIG. 1B can be operated to contribute a bias voltage to the voltage across the cells or string 2, so that the overall output 8 of the circuit matches a target voltage. The bias voltage may add to or subtract from the voltage contributed by the cells or string 2, dependent on the target voltage which is to be met. This is represented by the bidirectional arrows in FIG. 1B denoting the alternative “boost” and “buck” configurations available with the arrangement shown therein.

The converter 4 in FIG. 1B only contributes a bias voltage, which makes a relatively small change to the voltage or current of the PV cells or string 2. Thus, the power transferred by the converter 4 is only a function of the amount of the bias itself, not of the entire output 8 of the string 2 and converter 4 in combination. As one skilled in the art will appreciate, the losses of a DC/DC converter are inevitably a function of its power throughout its operation. Therefore, in the arrangement shown in FIG. 1B, the losses of the DC/DC converter 4 are proportionate only to the amount of the bias which it contributes. The converter power rating must therefore equal or exceed maximum bias power. It need not equal the maximum power for the cells or string 2.

Going back to the numerical example set out above in relation to FIG. 1A, if the same converter technique was used with the arrangement shown in FIG. 1B and if one allows for a maximum converter bias of 10% of the maximum output from the cells or string 2, then the converter's fixed loss would be 2 W and the variable loss would be 4 W. The equivalent conversion efficiency would be 99.4%. Hence the arrangement shown in FIG. 1B provides significant efficiency improvement over the prior art arrangements due to the method of operation of the selected DC/DC converter, regardless of the particulars of its internal design.

As will be recognized by one skilled in the art, prior art arrangements typically include a single DC/DC converter in conjunction with an entire array of photovoltaic (PV) cells. Such an array may include multiple strings of PV cells connected in series and/or parallel. In such a conventional arrangement, the power from the entire array would be input to the inverter. The arrangement would include an inverter controller which would operate an MPP algorithm to determine the optimal voltage for the entire array. This would be an aggregate value for the entire array, and not the optimum for each individual string. Each string would typically generate a few amps, for example in the region of 2 to 5A. However, a typical array could generate in the region of 1000A. Typical working voltages of a PV string could be in the region of 500V to 900V and would vary with temperature as is known. In contrast, typical values of the bias voltage imposable by the DC/DC converter according to the embodiments described herein, exemplified in FIG. 1B, could be in the region of 5% to 10% of the string voltage.

There are significant advantages of operating a DC/DC converter as shown in FIG. 1B. An individual DC/DC converter can be provided in series with each string, in series therewith. With an associated converter in series with each series string, the optimum voltage output conditions of each PV module, and hence the maximum power output point of each string as a whole, may be maintained regardless of any inverter parameter changes. Furthermore, each string may output a different optimum DC voltage to the other strings in an array as the respective converter buffers each string from the other strings in the array.

Turning to FIG. 1C, a more detailed example can be seen. As shown therein, multiple PV modules 10 are coupled together in series strings 11 or groups of series strings 11. Each series string 11 has a respective output terminal 12A, 12B. The series strings 11 may be coupled in parallel with other series strings 11 to form a parallel array 13 of PV modules. The parallel arrangement of the array 13 enables the PV series strings 11 to be configured such that the array 13 has common array output terminals 14A, 14B. These common terminals 14A, 14B may be connected to a common DC circuit such as a power processing system 16, which in a non-limiting example may be, an inverter. Additionally, series strings 11 and sub-arrays (not shown) may be grouped together in other combinations as the operating conditions may require.

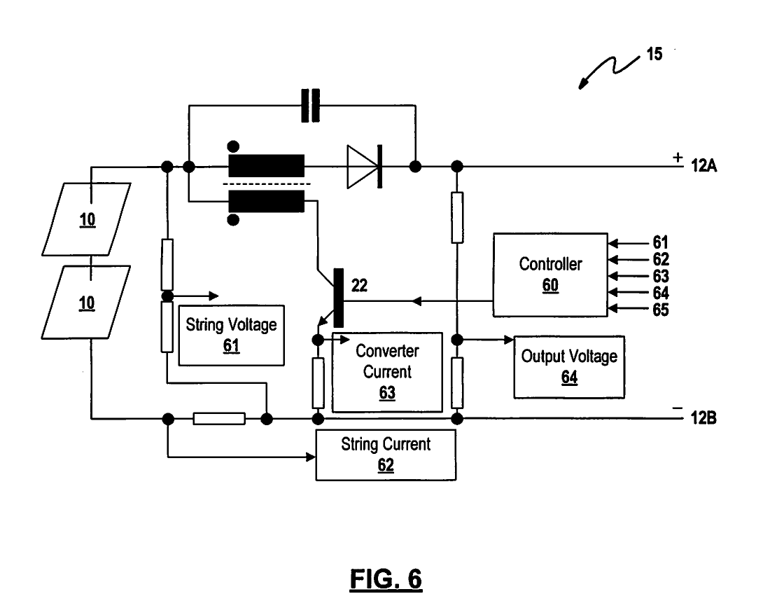

An inline DC/DC converter 15, or other voltage regulator is coupled in series with the PV modules of each series string 11. The converter 15 may be positioned at any point in the series string. Its position may be selected to suit physical constraints, the arrangement for earthing (grounding) due to different manufacturers of PV panels having different earthing requirements, or for enabling a convenient common connection with other series strings 11 by way of output terminals 12A, 12B. As is shown in FIG. 6, each converter 15 has an associated bias control system comprising support components and a Maximum Power Point (MPP) tracking algorithm within a controller.

As discussed in the background section above, for a given level of insolation and temperature, each PV cell or module has an optimal DC operating voltage. Ignoring any other circuit influences, each series string 11 will therefore present an optimum DC string voltage to the converter 15 that is variable according to the conditions.

In operation, when a series string 11 as shown in FIG. 1C is exposed to sunlight, the MPP algorithm, together with the control system, adjusts the converter 15 to provide a suitable bias voltage, to be combined with the voltage across the series string of PV modules, to provide a target voltage across output terminals 12A and 12B. Therefore, by using the inline converter 15, the voltage across the series string of PV modules may be adjusted independently of the voltage at the output terminals 12A, 12B.

The voltage at the terminals 12A, 12B typically remains largely constant under the control of the inverter 16 or other DC load, although it may be affected to some extent by the behaviour of the converter 15. Due to the compensating action of the converter 15, the string 11 as a whole can operate at an optimum DC voltage according to the string conditions and regardless of circuit conditions outside of the series string 11. The converter 15 can impose a bias voltage on the optimum DC voltage of the series string at any given time. Therefore the DC voltage across the string of PV modules can be changed and controlled over time in order to achieve maximum efficiency of the PV cells in the string, or to meet some other target, regardless of the voltage at the output terminals 12A, 12B.

When there are multiple series strings 11 present in the array 13, each series string, in conjunction with the bias voltage adjustment provided by the inline converter 15, can present a DC voltage across the series string output terminals that is substantially equal to that of other series strings. In turn, these substantially equal string output voltages present a common DC voltage across the common output terminals of the array 14A, 14B. The output across the terminals 14A, 14B of the array thus presents a substantially uniform DC voltage to the common inverter 16 or other load.

Thus, in effect, the converter 15 provides a buffer between the optimum voltage across the PV modules of a series string and the voltage output across the terminals 12A, 12B of the series string as a whole. It also provides compensation from external circuit influences on the series string output terminals that would otherwise influence the DC voltage of the PV modules of the series string 11 tending them away from their optimum level output voltage.

In the arrangement of a PV array with a biasing device in each string as illustrated in FIG. 1C, a common inverter 16 may be coupled to the PV array by way of the common array outputs 14A, 14B. The inverter 16 can thereby convert the DC output of the array 14A, 14B to an AC output 19 suitable for connection to the electrical distribution network of the location. This may be used for transmitting power back to the distribution network.

Even when an inverter 16 is connected to the common output terminals 14A, 14B of an array, the in line converter or converters 15 can, by imposing a bias voltage on the DC voltage produced by the series string, be controlled to make adjustments for the local operational conditions for each series string 11 independently of the other series strings, and hence independently of any influence of the common inverter 16 coupled to the common array output 14A, 14B. The common inverter 16 may be adjusted according to an overall MPP algorithm or optimized in accordance with, for example, the parameters of any power distribution system to which it is coupled without affecting the efficiency of each individual series string 11. Any change in inverter 16 parameters which may affect the properties of the inverter 16 input do not affect the optimum DC voltage output of each series string 11 as any change in voltage at the output terminals 12A, 12B of each series string 11 is compensated for by the inline converters 15. Thus, the adjustment enabled by converter 15 in each series string 11 allows the inverter 16 coupled across the array 13 to be adapted for optimal operational efficiency based on substantially stable outputs from each of the series strings 11.

There exist a number of power electronic switched-mode techniques for adjusting a DC voltage. These include operation any of a buck converter, a boost converter, and an inverter or rectifier. However the power loss in these techniques is such that the overall benefit in efficiency would be small if used in a conventional arrangement such as that shown in FIG. 1A.

The fixed power losses of such techniques are a function of the rated power throughput, and it is difficult to achieve losses of less than about 2% of rated power. Furthermore, the main power semiconductors are rated for the full range of possible input voltage and current. Therefore putting all the power from a string of PV modules through a buck converter, boost converter, inverter or receiver would not be efficient or cost effective.

By way of contrast, in the embodiments of FIGS. 1B to 5D, the converter 15 need only supply the required DC bias voltage such that a substantially equal DC voltage be presented across the output terminals 12A, 12B by each series string 11. Consequently, the power throughput of the converter is a function only of the DC bias voltage, and not of the full string DC output voltage. Thus, the power rating of the converter 15 is small compared with that of the full series string and the overall array rating, and is determined by the maximum required DC bias voltage. Fixed and variable losses in the converter 15 are substantially lower than those that would be present for a converter exposed to the full string voltage. This can also result in a reduction in the cost of the components forming the converter.

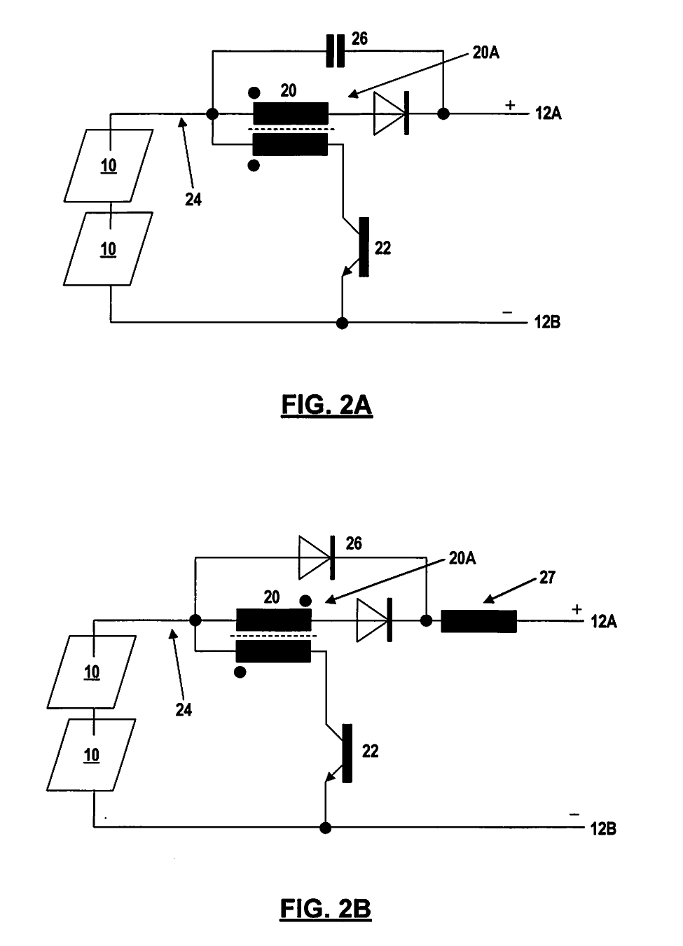

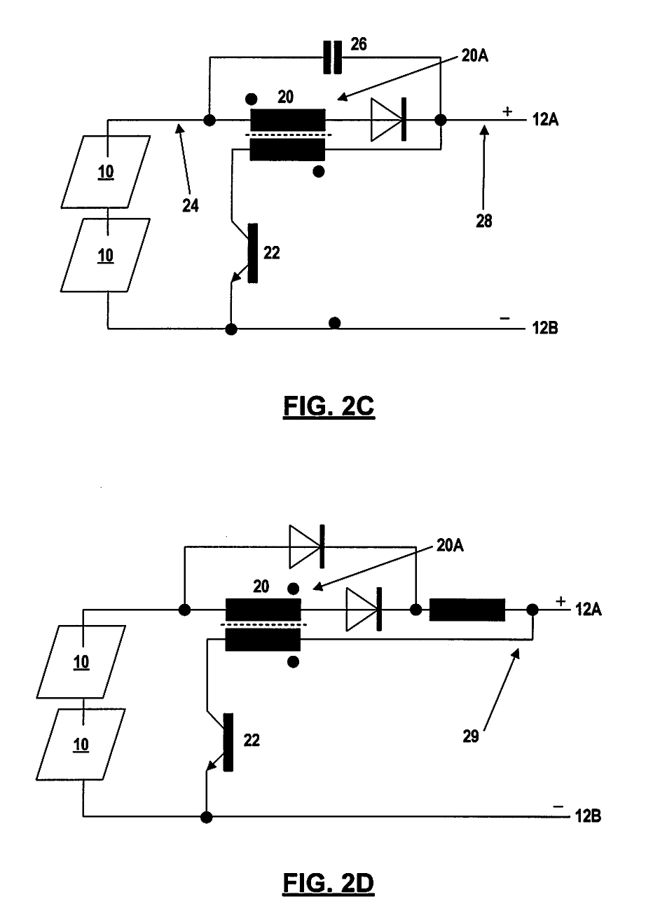

Turning to FIGS. 2A to 4B, a number of embodiments comprising different arrangements of converter 15 will be described. The converters may provide a positive potential (boost mode), negative potential (buck mode), or adjustable potential (bipolar) to the optimum DC series string voltage produced by the PV modules. Maintenance of the bias voltage requires a net output of power in the converter which is, of course, proportional to the bias voltage and the current flow in the converter.

In all illustrated embodiments, only the power semiconductor components are illustrated. One skilled in the art would recognize that there may also be additional components such as snubbers, freewheeling diodes, and de-magnetising diodes as would be understood by one skilled in the art.

FIGS. 2A to 2D show a boost mode converter where the flow of current is from the series string to the output terminals 12A, 12B. Specifically, FIGS. 2A and 2C show a flyback arrangement and FIGS. 2B and 2D show a forward arrangement. A boost mode converter would be employed where the minimum optimum series string voltage is a constraint on the inverter 16 input parameters.

In the embodiments of FIGS. 2A and 2B the converter input is coupled to the string output at 24. The output of the converter is coupled in series with the string output in order to increase the output voltage across output terminals 12A and 12B.

With the embodiment of FIG. 2A, when exposed to sunlight, a DC voltage is produced by the PV modules 10. By way of current induced in the windings of the transformer 20, energy is stored in the transformer magnetising inductance when transistor 22 is turned on, and delivered to the transformer secondary circuit 20A when the transistor is turned off. In another embodiment, the converter input may be taken from the converter output, illustrated at point 28 of FIG. 2C.

With the embodiment of FIG. 2B, power is delivered to the output 12A when the transistor 22 is turned on. By way of current induced in the inductance 27, energy is stored in the inductance 27 when transistor 22 is turned on, and delivered to the output circuit 12A continuously when transistor 22 is on or off, as would be understood by the skilled person. In another embodiment, the converter input may be taken from the output across the output terminals 12A, 12B illustrated at point 29 of FIG. 2D.

Some designs of PV panel require a blocking diode or anti-backfeed device, for example, at night when the strings do not receive any insolation, if there is a damaged string present in the array, or a particular string is in the shade. By appropriate choice of component voltage ratings, the boost mode embodiments of FIGS. 2A, 2B, 2C and 2D can provide this functionality.

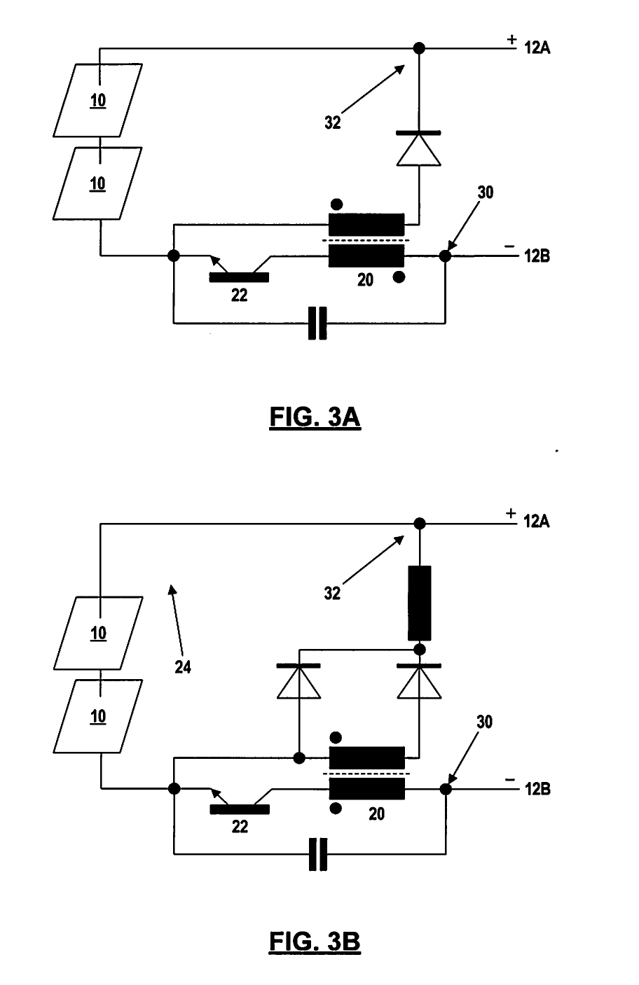

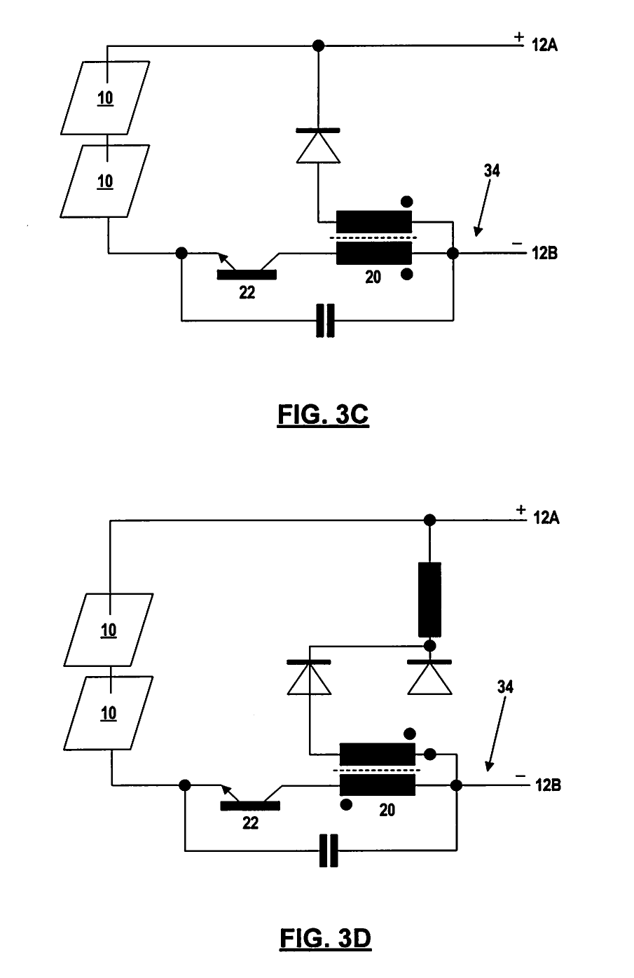

FIGS. 3A to 3D show buck mode converters where the flow of bias current is from the output terminals 12A, 12B to the series string 11. Specifically FIGS. 3A and 3C show a flyback arrangement and FIGS. 3B and 3D show a forward arrangement. A buck mode converter would be employed where the maximum series string voltage would be a constraint on the inverter 16 input parameters.

With the embodiment of FIG. 3A, the input of the converter is coupled in series with the string at point 30. This reduces the voltage delivered to the DC output across output terminals 12A, 12B. The output of the converter is connected in parallel with the string at point 32, adding to the available current from the string. In another embodiment, the converter output may be coupled to the output terminals 12A 12B rather than the string output illustrated at point 34 of FIG. 3C). This may result in a more efficient conversion.

With the embodiment of FIG. 3B, the input of the converter is coupled in series with the string at point 30. This reduces the voltage delivered to the DC output across output terminals 12A, 12B. The output of the converter is connected in parallel with the string, adding to the available current from the string. In another embodiment, the converter output may be coupled to the output terminals 12A, 12B rather than the string, illustrated at point 34 of FIG. 3D). This may result in a more efficient conversion.

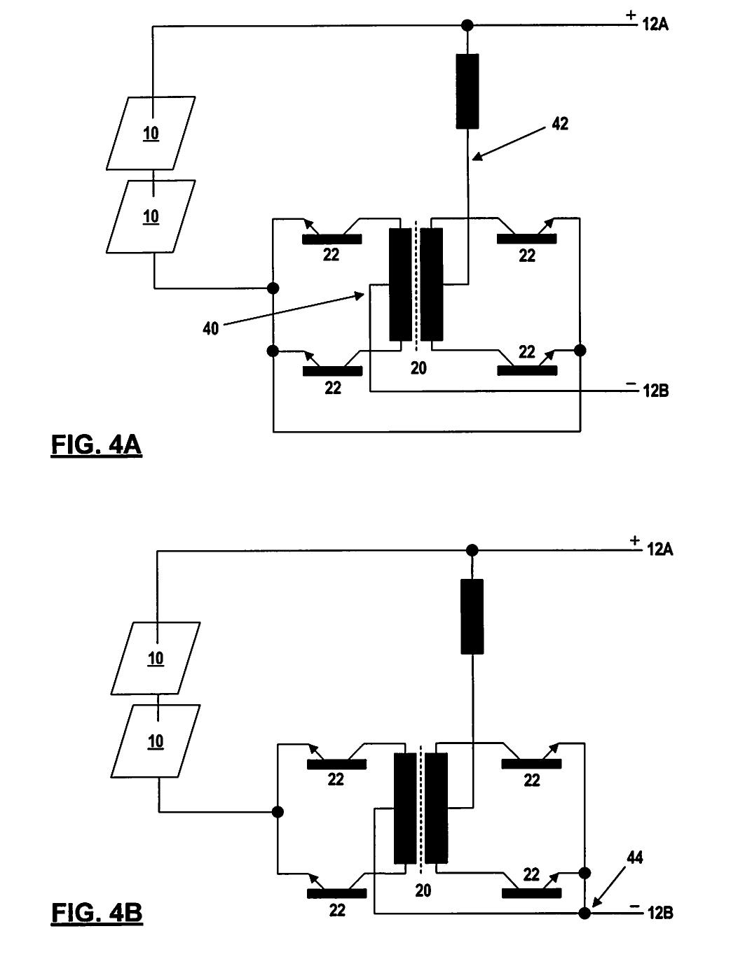

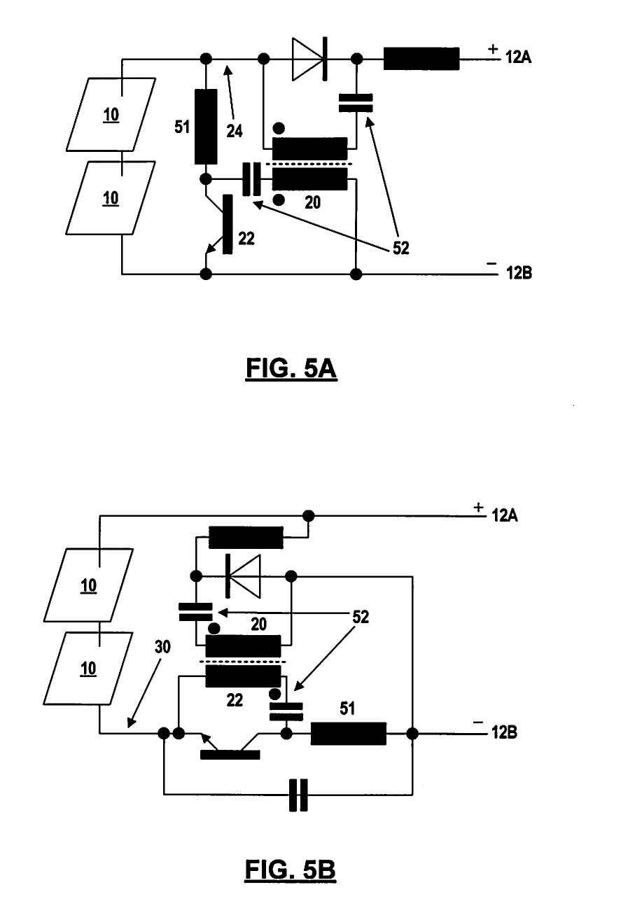

Turning to FIG. 4A, a push-pull converter in bipolar mode is shown with an active rectifier. A bipolar mode converter would be employed where the series string voltage is close to the average required at the inverter 16 input and therefore requires a relatively small bias voltage, which may be either positive or negative with respect to the optimum string voltage output as required. This arrangement hence allows the lowest conversion losses in the converter.

The fully controlled push-pull converter can operate over a range of conditions by adjusting the relative phase of the control signals to the transistors 22 on either side of the transformer 10, and power can flow in either direction. The left side of transformer 20 is coupled in series 40 with the string whilst the right side is coupled in parallel 42. Power may be extracted in series and added in parallel, giving a voltage reduction, or extracted in parallel and added in series, giving a voltage increase to the voltage output across terminals 12A, 12B. In another embodiment, the parallel branch (right hand side of transformer 20) may be coupled to the output across terminals 12A, 12B rather than the string, illustrated at point 44 of FIG. 4B. This embodiment may be more efficient when providing buck conversion.

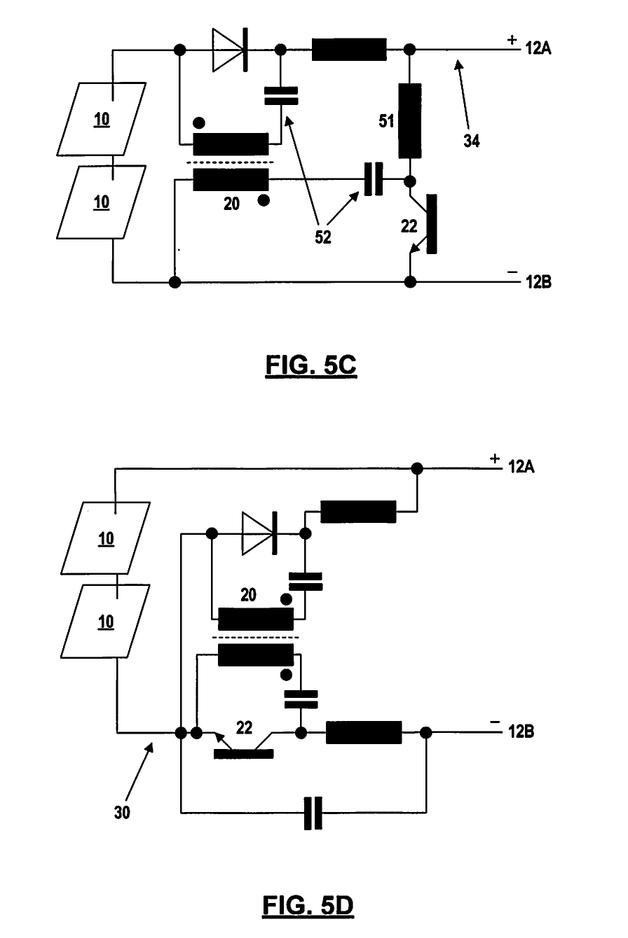

In a further embodiment, a unipolar mode could be obtained by way of replacing two of the transistors 22 shown in FIGS. 4A and 4B with diodes as would be clear to the skilled person. The side of the transformer with the diodes would be the converter output. When the converter output is on the left hand side of transformer 20, operation would be in the boost mode and, when it is on the right hand side of transformer 20, operation would be in the buck mode. In a further embodiment, as shown in FIGS. 5A to 5D, a Ćuk converter may be used.

With the Ćuk converter boost mode embodiment of FIG. 5A, a DC voltage is produced by the PV modules 10. Energy is stored in the inductance 51 when transistor 22 is turned on. When the transistor 22 is turned off, energy is delivered to the transformer primary circuit 20, and hence to the secondary rectifier circuit, through the coupling capacitors 52. The converter input is coupled to the string output at 24. The output of the converter is coupled in series with the string output in order to increase the output voltage across output terminals 12A and 12B.

With the Ćuk converter buck mode embodiment of FIG. 5B, the input of the converter is coupled in series with the string at point 30. This reduces the voltage delivered to the DC output across output terminals 12A, 12B. The output of the converter is connected to the output terminals, adding to the available current from the string.

In a further embodiment of the Ćuk converter boost mode, the converter input may be coupled to the output terminals 12A, 12B rather than the string output, illustrated at point 34 of FIG. 5C. This may result in a more efficient conversion.

In a further embodiment of the Ćuk converter buck mode, the converter output may be coupled to the string output rather than the output terminals 12A, 12B illustrated at point 30 of FIG. 5D. This may result in a more efficient conversion.

In all embodiments, the bipolar transistor(s) could also be, for example, MOSFETs or insulated gate bipolar transistors (IGBT) or any combination thereof.

Many of the embodiments described above can be arranged such that any failure in the power semiconductors results in a fall-back state. For example, in the circuit of FIG. 2A, if the transistor 22 fails to conduct because of a fault, continuity between the string and the output is inherently maintained through the transformer 20 secondary winding and the diode. If the transistor 12 were to become a short circuit, then a protection device, for example a fuse opens and continuity is again maintained. Because of the low power throughput of the converter, co-ordination of the protection device with the prospective short circuit current is simplified. Most commonly, failure modes occur where the boost/buck function is lost but the string is still connected to the output terminals 12A, 12B. In this event, and with the fall-back state available, the string can continue to deliver power at a sub-optimal MPP level. This is in contrast to a traditional full converter where a failure in the power semiconductors may result in a total loss of string output.

FIG. 6 illustrates an embodiment showing a flyback boost converter arrangement as illustrated in FIG. 2A arranged as part of a bias control system.

A controller 60 is associated with each converter 15 and contains an MPP tracking algorithm. The algorithm may be provided by way of software download to a programmable controller device 60 such as, but not limited, to a microcontroller, or may be hard-wired into the controller 60 by other means such as an application specific integrated circuit (ASIC). The support components which, as can be seen, can be low-cost resistive components, provide measurement points of the series string, and enable the controller 60 to be supplied with the information upon which the MPP algorithm contained within is applied.

The controller 60 receives series string inputs of string voltage 61 and string current 62, and may also receive converter current 63 and adjusted string output voltage 64. As previously described, the converter 15 is self-contained, requiring no external coupling to any other series string. The controller 60 is able to turn the transistor 22 on and off to provide a pulse-width modulation to the flow of current in the converter 15. This action imposes a corresponding positive bias on the optimum DC voltage output of the series string of PV modules, resulting in an independently controllable DC string output voltage across terminals 12A and 12B.

As has been explained above, the bias voltage imposed on the series string voltage is adjusted in order to maintain the voltage output at the series string output terminals 12A, 12B in line with other series strings 11 in the array 13.

The converter 15, is typically independent and self-contained. However, the controller 60 may be provided with data communications capabilities. A separate control input 65 to the controller 60 can be used by an external system to send a control signal to the controller 60. This could, for example, adjust the action of the converter 15 such that the bias voltage imposed on the series string 11 can be adjusted for reasons external to the converter 15, rather than for maintaining the voltage substantially constant across the series strings. The local measurements provided by inputs 61 to 64 could, therefore, be overridden by the separate control input 65 if desired. Additionally or alternatively, the controller 60 may be provided with condition monitoring capabilities to communicate monitoring data such as series string operating parameters to a remote monitoring device.

The embodiment illustrated in FIG. 6 includes a controller 60 for its respective converter in each string. However, a single controller may also be arranged to monitor and control two or more converters in their respective strings. This requires a controller of sufficient processing speed and power to enable multiplexing without affecting controller performance.

The string voltage and current and the output voltage data can be used to detect likely faults in a series string, string box or string box interconnection. A string box is a unit located in the vicinity of the array to marshal the connections to a group of individual strings and to provide various facilities for interconnection with other string boxes, over-current protection, isolation for maintenance purposes, and monitoring for condition and safety reasons. A string box interconnection is a connection between string boxes, which gathers the output from the boxes for transfer to the array output.

Thus a system is provided which enables individual adjustment to each series string 11 to be made in order to achieve a desired string output voltage across its output terminals 12A, 12B to buffer the optimum output voltage of the PV modules and to compensate for external circuit influences.

With all embodiments, neither the converter 15 nor the associated components need provide galvanic isolation as each series string 11 operates independently and there is generally only a unipolar (positive or negative) potential between the PV panel and earth. Furthermore, there is always one common coupling between each series string and the DC busbar. This negates problems associated with common-mode voltages attributable to the switching action of a converter 15 or inverter 16.

The choice of a suitable bias voltage range for the boost or buck function allows optimisation of the system cost and efficiency. The component cost and power loss of the embodiments described are approximately proportional to the maximum bias voltage provided by the converter in each string.

In known systems, there may be insufficient knowledge to make a fully informed choice of the bias voltage range that the system will need to provide during its lifetime. The present system enables adaption to changing PV string characteristics during the lifetime of the panels, and particularly the diversity of their characteristics, can be undertaken. These characteristics could change with, for example, age of the panels, contamination of the panels, the replacement of panels with those of a differing manufacturer, and other unknown effects which will may only become apparent after long term usage.

Furthermore, if a PV string 11 displays such an altered characteristic that its associated converter 15 cannot achieve the MPP, the converter 15 can operate at the best available setting, under the influence of the controller 60. The controller 60 may be able to indicate this limiting condition by way of its aforementioned data communications capabilities. An additional converter could then be added in series to provide an extended bias voltage range without the need to hold stocks of alternative converter types. There is no need for the inline converter 15 to itself have any intelligence, to change its bias for example from 5% to 10%, since a separate controller can be provided to monitor operation of the inline converter and the series string as a whole and additional or alternative inline converters can be added simply and easily if needed.

The embodiments described hereabove can be achieved by retrofitting a DC/DC converter within an existing series string of PV modules. This could replace existing converters which are arranged to convert the entire output of a series string or array, hence, resulting in significant energy savings.

When an inverter is used as a load across the common outputs of a PV array as shown in FIG. 1C, such an inverter can monitor the output of the array. It can therefore detect whether a particular DC/DC converter can optimise the output of the associated string at a particular voltage. The inverter can also balance the requirements of optimising each string or array with increasing its own efficiency, which is also temperature sensitive.

The embodiments and arrangements as described herein can be implemented in a range of different PV strings and arrays, for use with any suitable load at the output. Furthermore, the aforementioned arrangements of a converter positioned in a series string of PV modules is equally applicable to any system where it is desired that an optimum voltage output of a certain device be shielded or buffered from external circuit influences. The optimum voltage output of the device may continue to be produced while other parts of the circuit are only subjected to the voltage produced after the converter has imposed its compensating bias voltage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-22. (canceled)

23. An apparatus for producing a compensated voltage output comprising:
at least one photovoltaic module; and
biasing means connected in series with the at least one photovoltaic module,
the biasing means being operable to generate a controllable bias voltage for modulating an output voltage of the at least one photovoltaic module to produce the compensated voltage output, the power throughput of said biasing means being proportional only to the bias voltage generated by the biasing means.

24. The apparatus as claimed in claim 23 further comprising a plurality of photovoltaic modules coupled together in series and wherein the biasing means is coupled in series with the photovoltaic modules to form a series string with voltage output terminals.

25. The apparatus as claimed in claim 24 wherein the biasing means compares a DC to DC converter.

26. The apparatus as claimed in claim 24 comprising a plurality of the series strings, at least two series strings being coupled in parallel such that the output terminals of the series strings provide a common photovoltaic module array output.

27. The apparatus as claimed in claim 23 wherein the biasing means comprises a DC to DC converter.

28. The apparatus as claimed in claim 23 wherein the biasing means comprises a boost converter.

29. The apparatus as claimed in claim 23 wherein the biasing means comprises a buck converter.

30. The apparatus as claimed in claim 29 wherein the converter is a flyback converter.

31. The apparatus as claimed in claim 29 wherein the converter is a forward converter.

32. The apparatus as claimed in claim 27 wherein the converter is a bipolar converter.

33. The apparatus as claimed in claim 32 wherein the converter is a push-pull converter.

34. The apparatus as claimed in claim 27 wherein the converter comprises a Ćuk converter.

35. An apparatus for producing a compensated voltage output comprising:
at least one photovoltaic module; and
a biasing module connected in series with the at least one photovoltaic module,
the biasing module being operable to generate a controllable bias voltage for modulating an output voltage of the at least one photovoltaic module to produce the compensated voltage output, the power throughput of said biasing module being proportional only to the bias voltage generated by the biasing module.

36. The apparatus as claimed in claim 35 further comprising a plurality of photovoltaic modules coupled together in series and wherein the biasing module is coupled in series with the photovoltaic modules to form a series string with voltage output terminals.

37. The apparatus as claimed in claim 36 comprising a plurality of the series strings, at least two series strings being coupled in parallel such that the output terminals of the series strings provide a common photovoltaic module array output.

38. The apparatus as claimed in claim 35 wherein the biasing module comprises a DC/DC converter.

39. The apparatus as claimed claim 35 wherein the biasing module comprises a boost converter.

40. The apparatus as claimed claim 35 wherein the biasing module comprises a buck converter.

41. The apparatus as claimed in claim 39 wherein the converter is a flyback converter.

42. The apparatus as claimed in claim 39 wherein the converter is a forward converter.

43. The apparatus as claimed in claim 38 wherein the converter is a bipolar converter.

44. The apparatus as claimed in claim 43 wherein the converter is a push-pull converter.

45. The apparatus as claimed in claim 38 wherein the converter comprises a Ćuk converter.

46. The apparatus as claimed in claim 35 wherein the biasing module further comprises:
a control module; and
series string voltage and series string current measuring means;
wherein the control module is operable to control the bias voltage imposed on to the voltage output of the series string according to the series string voltage and the series string current measurements.

47. The apparatus as claimed in claim 46 wherein the control module is arranged to control the current flowing in the biasing module.

48. The apparatus as claimed in claim 47 wherein the control module comprises an input for receiving a control signal such that the bias voltage is controllable by the received control signal.

49. The apparatus as claimed in claim 48 wherein the control module further comprises a data communication module for providing series string operating data to a monitoring module such that operating parameters of the series string can be remotely monitored.

50. The apparatus as claimed in claim 37 wherein the array is coupled to a common inverter.

51. A method of compensating a voltage output comprising:
exposing at least one photovoltaic module to light such that a DC output voltage is produced by the photovoltaic module; and
modulating the output voltage with a biasing voltage generated by a biasing circuit such that the voltage output is compensated, the power throughput of said biasing circuit being proportional only to the bias voltage generated by the biasing circuit.

52. The method as claimed in claim 51 further comprising:
measuring the series string voltage and the series string current;
inputting the measurements to a maximum power point algorithm of a control device of the biasing circuit;
providing a control output from the control device to control the biasing voltage imposed by the biasing circuit such that the output voltage is modulated with a biasing voltage according to the series string voltage and the series string current measurements.

53. The method as claimed in claim 51 further comprising :
receiving at the control device, an input signal from an external device external to the string where the biasing circuit is positioned; and adjusting the control output such that the biasing voltage is controllable by the external device.

54. The method as claimed in claim 51 further comprising:
providing series string operating data to a monitoring device such that operating parameters of the series string can be remotely monitored.
